(19) United States
(12) Patent Application Publication
(10) Pub. No.: US 2026/0021430 A1
(43) Pub. Date: Jan. 22, 2026

(54) SCREEN WITH A GEAR RACK FOR A SHAKER SYSTEM

(71) Applicant: Schlumberger Technology Corporation, Sugar Land, TX (US)

(72) Inventor: Claire Rosaleen Galloway McLean, Musselburgh (GB)

(21) Appl. No.: 18/778,613

(22) Filed: Jul. 19, 2024

(51) Int. Cl. B01D 33/80; B01D 33/03; B01D 33/37; E21B 21/06

(52) U.S. Cl. CPC B01D 33/803; B01D 33/0376; B01D 33/37; E21B 21/065; B01D 2201/0415; B01D 2201/24

(57) ABSTRACT

A screen includes a screen with a screen frame and a screen filter. The screen frame includes lateral frame members on opposite lateral sides of the screen frame. At least one gear rack extends along at least one frame member of the lateral frame members. The screen may be utilized in a shaker system to process a fluid (e.g., drilling fluid).

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Natural resources, such as oil and gas, are used as fuel to power vehicles, heat homes, and generate electricity, in addition to various other uses. Once a desired resource is discovered below a surface of the earth, drilling systems are often employed to carry out drilling operations to access the desired resource. During the drilling operations, drilling fluid is pumped through a drill string into a wellbore to facilitate drilling a well. The drilling fluid then flows through an annular space defined between the drill string and the wellbore to return to equipment located at a surface. The drilling fluid carries cuttings from the wellbore to the equipment located at the surface, and it is often desirable to separate the drilling fluid from the cuttings in order to recycle (e.g., reuse) the drilling fluid.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a screen includes a screen with a screen frame and a screen filter. The screen frame includes lateral frame members on opposite lateral sides of the screen frame. At least one gear rack extends along at least one frame member of the lateral frame members.

In certain embodiments, a system includes a screen with a screen frame and a screen filter, wherein the screen frame comprises at least one gear rack. The system also includes at least one gear configured to engage the at least one gear rack to facilitate installation of the screen within a housing.

In certain embodiments, a method includes inserting a first screen into a housing at a first end of the housing to engage at least one respective gear rack of the first screen with at least one gear that is positioned at a first location along a longitudinal axis of the housing. The method also includes driving rotation of the at least one gear while the at least one gear is engaged with the at least one respective gear rack of the first screen to drive the first screen to move toward a second end of the housing to facilitate installation of the first screen in the housing.

### BRIEF DESCRIPTION OF THE DRAWINGS

Various features, aspects, and advantages of the present disclosure will become better understood when the following detailed description is read with reference to the accompanying figures in which like characters represent like parts throughout the figures, wherein:

FIG. 1 is a schematic illustration of a shaker system, in accordance with an embodiment of the present disclosure;

FIG. 2 is a bottom view of a portion of a screen that may be utilized in the shaker system of FIG. 1, in accordance with an embodiment of the present disclosure;

FIG. 3 is a top perspective view of the screen of FIG. 2, in accordance with an embodiment of the present disclosure;

FIG. 4 is a bottom perspective view of the screen of FIG. 2, in accordance with an embodiment of the present disclosure;

FIG. 5 is a top view of the screen of FIG. 2 within a portion of the shaker system of FIG. 1, in accordance with an embodiment of the present disclosure;

FIG. 6 is a side perspective view of the screen of FIG. 2 in contact with a clamp within a portion of the shaker system of FIG. 1, in accordance with an embodiment of the present disclosure;

FIG. 7 is a side perspective view of the screen of FIG. 2 engaged by the clamp of FIG. 6 within the portion of the shaker system of FIG. 1, in accordance with an embodiment of the present disclosure;

FIG. 8 is a top perspective view of a screen that may be utilized in the shaker system of FIG. 1, in accordance with an embodiment of the present disclosure;

FIG. 9 is a bottom perspective view of the screen of FIG. 8, in accordance with an embodiment of the present disclosure;

FIG. 10 is a top perspective view of a screen that may be utilized in the shaker system of FIG. 1, in accordance with an embodiment of the present disclosure;

FIG. 11 is a top perspective view of a screen that may be utilized in the shaker system of FIG. 1, in accordance with an embodiment of the present disclosure;

FIG. 12 is a flow diagram of a method of installing multiple screens into a shaker housing of a shaker system, in accordance with an embodiment of the present disclosure; and

FIG. 13 is a flow diagram of a method of removing multiple screens from a shaker housing of a shaker system, in accordance with an embodiment of the present disclosure.

### DETAILED DESCRIPTION OF SPECIFIC EMBODIMENTS

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted herein, during drilling operations, drilling fluid is pumped through a drill string into a wellbore to facilitate drilling a well. The drilling fluid then flows through an annular space defined between the drill string and the wellbore to return to equipment located at a surface. The drilling fluid carries cuttings from the wellbore to the equipment located at the surface, and it is often desirable to separate the drilling fluid from the cuttings in order to recycle (e.g., reuse) the drilling fluid.

A shaker (e.g., shale shaker; vibratory separator; shaker system) is a vibrating sieve-like table that separates solids from fluids. In certain operations, a drilling fluid that carries cuttings is deposited at a feed end of the shaker. As the drilling fluid and the cuttings travel along a length of the shaker, the drilling fluid falls through perforations in a screen filter of a screen to a reservoir and the cuttings are conveyed via vibration along the screen to a discharge end of the shaker.

It is presently recognized that it is desirable to efficiently install the screen into the shaker and to remove the screen from the shaker, and particularly to efficiently install and remove the screen from a front end of the shaker (e.g., at the discharge end of the shaker; as opposed to a side of the shaker). Accordingly, embodiments disclosed herein generally relate to a screen that includes at least one gear rack (e.g., a series of teeth formed in a frame member of a screen frame of the screen). The at least one gear rack of the screen is configured to engage with at least one gear (e.g., spur gear; toothed wheel) of a gear assembly of the shaker. Thus, the screen may be moved relative to the shaker via rotation of the at least one gear while the at least one gear rack is engaged with the at least one gear. In this way, an operator (e.g., a human operator; a machine operator, such as an actuator or motor) may drive rotation of the at least one gear (e.g., by rotating a handle and/or a drive shaft of the gear assembly) to install and remove the screen at the shaker.

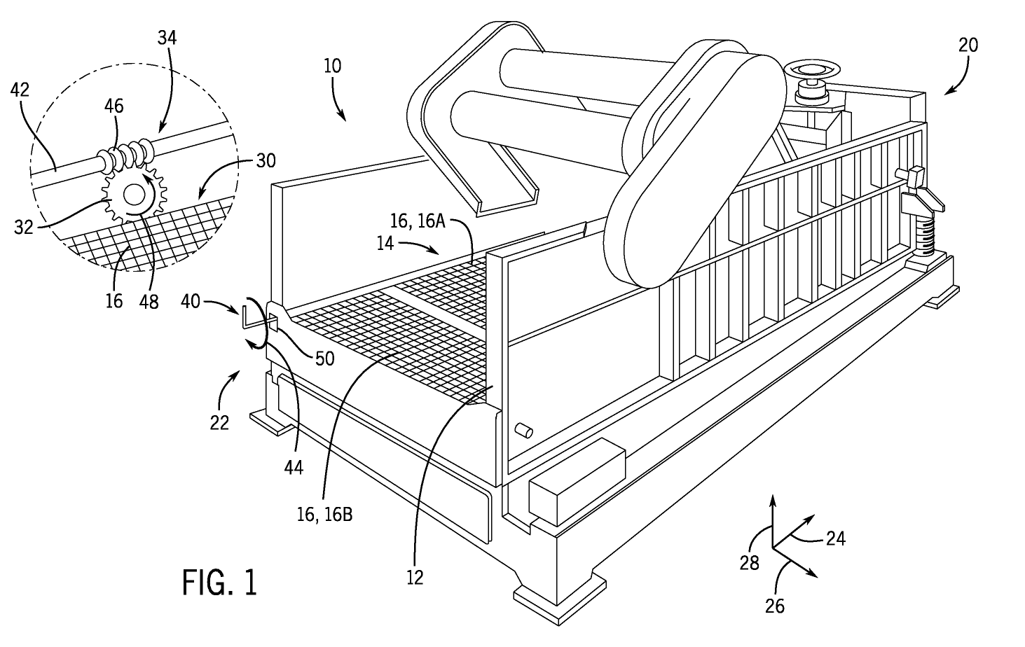

With the foregoing in mind, FIG. 1 is a schematic illustration of a shaker system 10, in accordance with an embodiment of the present disclosure. The shaker system 10 may include a shaker housing 12 (e.g., shaker frame) that supports a screen assembly 14 (e.g., shaker screen assembly). The screen assembly 14 includes one or more screens 16 (e.g., one or more shaker screens). For example, the screen assembly 14 may include multiple screens 16 configured to couple to one another.

The shaker system 10 may extend from a feed end 20 (e.g., back or distal end) to a discharge end 22 (e.g., front or proximal end). To facilitate discussion, the shaker system 10 and/or components therein may be described with reference to a longitudinal axis or direction 24, a lateral axis or direction 26, and/or a vertical axis or direction 28. Further, the longitudinal axis or direction 24, the lateral axis or direction 26, and/or the vertical axis or direction 28 may be described and utilized herein as relative axes or directions, such as relative to the shaker housing 12, relative to the one or more screens 16, and so forth.

As described herein and as shown in an inset of FIG. 1, each of the one or more screens 16 may include at least one gear rack 30 (e.g., a series of teeth formed in a frame member of a screen frame of the screen). The at least one gear rack 30 is configured to engage with at least one gear 32 (e.g., spur gear; toothed wheel) of a gear assembly 34 of the shaker system 10. Thus, each of the one or more screens 16 may be moved relative to the shaker housing 12 via rotation of the at least one gear 32 while the at least one gear rack 30 is engaged with the at least one gear 32. In this way, an operator (e.g., a human operator; a machine operator, such as an actuator or motor) may drive rotation of the at least one gear 32, such as by rotating a handle 40 and/or a drive shaft 42 of the gear assembly 34, to install and remove the one or more screens 16 at the shaker housing 12. It should be appreciated that the screen assembly 14 and the gear assembly 34 may be referred to as a screen system (e.g., a screen drive system), which may be utilized with the shaker housing 12 and various other components to form the shaker system 10.

In FIG. 1, the gear assembly 34 is shown to include the handle 40 that is accessible from an exterior of the shaker housing 12, such as at the discharge end 22. Accordingly, the human operator may grip the handle 40 and apply a force to the handle 40 to rotate the handle 40 in a first handle rotational direction, such as shown by arrow 44 (e.g., about the longitudinal axis 24 of the shaker housing 12). In FIG. 1, the handle 40 may include or be coupled to the drive shaft 42 that rotates with the handle 40, and the drive shaft 42 may drive rotation of the gear 32. As one example, in FIG. 1, the drive shaft 42 may include or be coupled to a worm gear 46 that contacts and engages the at least one gear 32 to drive the at least one gear 32 to rotate in a first gear rotational direction, such as shown by arrow 48 (e.g., about the vertical axis 28 of the shaker housing 12). In turn, via engagement between the at least one gear 32 and the at least one gear rack 30, the rotation of the at least one gear 32 in the first gear rotational direction drives the one or more screens 16 toward the feed end 20 to eventually reach an installed position (e.g., installed configuration) in the shaker housing 12.

It should be appreciated that the gear assembly 34 may have any suitable form to facilitate or to drive rotation of the at least one gear 32 in the first gear rotational direction (and in a second gear rotational direction, opposite the first gear rotational direction). For example, the handle 40 and/or the drive shaft 42 may be oriented along the vertical axis 28 of the shaker housing 12, and the drive shaft 42 may be fixed to the gear 32 (e.g., non-rotatably coupled; rotate together).

As described herein, the one or more screens 16 may include multiple screens 16 that may be installed together (e.g., in series) at the shaker housing 12 to form a deck (e.g., screen deck; filter deck) that extends from the feed end 20 to the discharge end 22. In certain embodiments, each of the multiple screens 16 may include a same structure (e.g., identical structure, geometry, configuration; only minor variations due to manufacturing tolerances) to facilitate manufacturing and/or operations. Thus, each of the multiple screens 16 may include at least one respective gear rack 30 that is configured to engage the at least one gear 32 of the gear assembly 34.

Accordingly, the operator may place a first screen 16A of the multiple screens 16 into the shaker housing 12 at the discharge end 22. Then, the at least one gear 32 of the gear assembly 34 may be rotated (e.g., in the first gear rotational direction) to drive the first screen 16A toward the feed end 20. Then, the operator may place a second screen 16B of the multiple screens 16 into the shaker housing 12 at the discharge end 22. Then, the at least one gear 32 of the gear assembly 34 may be rotated to drive the second screen 16B toward the feed end 20.

In certain embodiments, contact between the second screen 16B and the first screen 16A may drive the first screen 16A further toward the feed end 20. Eventually, the first screen 16A will reach the feed end 20, and the first screen 16A may engage a clamp (e.g., a rotatable clamp; an inflatable bladder) that holds the first screen 16A at the feed end 20. Additionally or alternatively, the at least one gear 32 of the gear assembly 34 may be locked (e.g., blocked or prevented from rotating), such as via at least one lock 50. The at least one lock 50 may be at any suitable location (e.g., at the handle 40; accessible and/or actuatable at the exterior of the shaker housing 12) to block rotation of the at least one gear 32, which may maintain the multiple screens 16 in the installed position with leading and trailing edges of adjacent screens (e.g., the first screen 16A and the second screen 16B) of the multiple screens 16 in contact and/or sealed against one another (e.g., via elastomer and/or metal seals).

In certain embodiments, each of the multiple screens 16 may include latch features (e.g., corresponding protrusions and recesses) along the leading and trailing edges to couple the multiple screens 16 to one another and to block separation of the multiple screens 16 from one another in the installed position. Further, the latch features may facilitate removal of the multiple screens 16 from the shaker housing 12. For example, the operator may drive rotation of the at least one gear 32 of the gear assembly 34 (e.g., in a second gear rotational direction that is opposite the first gear rotational direction) to drive the multiple screens 16 toward the discharge end 22. That is, the at least one gear 32 may engage with the at least one gear rack 30 of one of the multiple screens 16 (e.g., the second screen 16B or other screen proximate to the discharge end 22), and the rotation of the at least one gear 32 of the gear assembly 34 (e.g., in the second rotational direction) drives the one of the multiple screens 16 and any other screens of the multiple screens 16 that are coupled (directly or indirectly) to the one of the multiple screens 16 via the latch features, toward the discharge end 22.

In certain embodiments, each of the multiple screens 16 may be devoid of latch features at the leading and trailing edges, and thus the multiple screens 16 do not latch to one another when the multiple screens 16 are installed together at the shaker housing 12. Instead, the gear assembly 34 may include multiple gears 32 distributed between the feed end 20 and the discharge end 22. In some such cases, each of the multiple gears 32 may be independently engaged and disengaged from the handle 40 (and/or the drive shaft 42) and the at least one gear rack 30, such as via mechanical linkage assemblies. In some such cases, each of the multiple gears 32 may be independently rotated via a dedicated handle and/or a dedicated drive shaft positioned or accessed at the discharge end 22 (e.g., stacked vertically or laterally with respect to one another, with linkages to extend along the shaker housing 12 to the multiple gears 32 distributed between the feed end 20 and the discharge end 22). In some such cases, each of the multiple gears 32 may be independently rotated via a dedicated handle and/or a dedicated drive shaft positioned or access along lateral sides of the shaker housing 12 and spaced apart between the feed end 20 and the discharge end 22 (e.g., aligned with and fixed to a respective gear 32 along the longitudinal axis 24 of the shaker housing 12).

Accordingly, the multiple screens 16 may be placed in the installed position as described herein; however, the multiple screens 16 may be removed from the shaker housing 12 via rotation of the multiple gears 32 simultaneously and/or sequentially (e.g., one gear 32 proximate to the feed end 20 engages and drives the first screen 16A that is closest to the feed end 20 to hand off the first screen 16A to another gear 32 closer to the discharge end 22, which then engages and drives the first screen 16A to hand off the first screen 16A to yet another gear 32 closer to the discharge end 22, and so forth until all of the multiple screens 16 are removed from the discharge end 22; such movement of the first screen 16A drives movement of the second screen 16B and any other screens 16 of the multiple screens 16 via contact between the leading and trailing edges of the adjacent screens of the multiple screens 16).

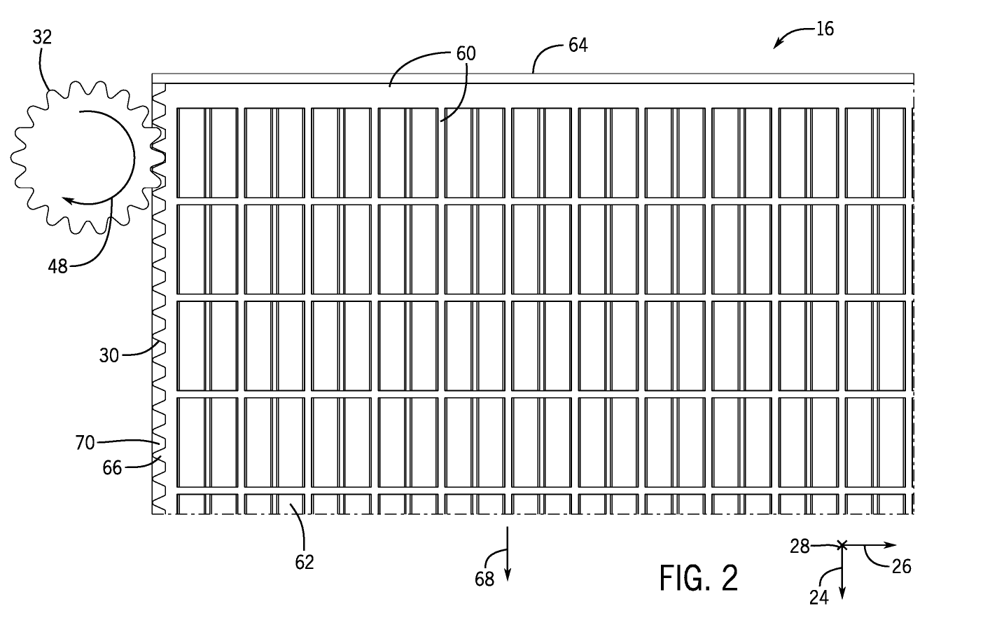

FIG. 2 is a bottom view of a portion of one screen 16 that may be utilized in the shaker system 10 of FIG. 1, in accordance with an embodiment of the present disclosure. The screen 16 includes a screen frame 60 and a screen filter 62 (e.g., mesh). The screen frame 60 may include or provide a leading edge (e.g., first edge or side; leading edge support member; not shown in FIG. 2) and a trailing edge 64 (e.g., second edge or side; trailing edge support member). The leading edge and the trailing edge 64 are spaced apart from one another along the longitudinal axis 24 of the screen 16 (e.g., on opposite longitudinal sides of the screen 16).

It should be appreciated that, with reference to FIGS. 1 and 2, the screen 16 may be installed into the shaker housing 12 of the shaker system 10 with the leading edge (rather than the trailing edge 64) closer to the feed end 20 and with the trailing edge 64 (rather than the leading edge) closer to the discharge end 22. Advantageously, in embodiments without latch features along the leading edge and the trailing edge 64, the leading edge and the trailing edge 64 may have a same structure (e.g., identical structure, geometry, configuration; only minor variations due to manufacturing tolerances). Thus, the screen 16 may be installed with either longitudinal side facing the feed end 20 (e.g., either longitudinal side may form or be used as the leading edge).

As shown in FIG. 2, the screen frame 60 includes multiple frame members, such as a first side member 66 on a lateral side of the screen 16. The first side member 66 extends along the longitudinal axis 24 of the screen 16 (e.g., between the leading edge and the trailing edge 64). Further, the first side member 66 may include or be coupled to the at least one gear rack 30, which may include a series of teeth (e.g., alternating protrusions and grooves). The at least one gear rack 30 may extend over most (e.g., at least 50, 60, 70, 80, or 90 percent) of a length of the first side member 66 and/or the screen 16 (e.g., along the longitudinal axis 24; the length between the leading edge to the trailing edge).

In FIG. 2, the at least one gear rack 30 includes the series of teeth that face toward and are open to the lateral side of the screen 16 (e.g., face toward and are open along the lateral axis 26). Thus, in FIG. 2, the at least one gear rack 30 is configured to engage with the at least one gear 32 that is positioned (e.g., oriented) to rotate about the vertical axis 28 (e.g., in the first gear rotational direction, as shown by the arrow 48, and the second gear rotational direction opposite the first gear rotational direction) to drive the screen 16 along the longitudinal axis 24 (e.g., in a first screen direction, as shown by arrow 68, and a second screen direction opposite the first screen direction). For example, the at least one gear rack 30 may rotate in the first gear rotational direction to drive the screen 16 in the first screen direction toward the feed end 20 of FIG. 1, and the at least one gear rack 30 may rotate in the second gear rotational direction to drive the screen 16 in the second screen direction toward the discharge end 22 of FIG. 1.

In FIG. 2, the at least one gear rack 30 is laterally recessed and/or covered by a ledge portion 70 of the screen 16 (e.g., relative to the vertical axis 28; when installed in the shaker housing 12 of FIG. 1). The ledge portion 70 of the screen 16 may include a laterally extending portion of the screen frame 60 and/or a laterally extending portion of the screen filter 62. In this way, the ledge portion 70 may block debris (e.g., the cuttings) from reaching the at least one gear rack 30 and/or interfering (e.g., blocking) in engagement between the at least one gear rack 30 and the at least one gear 32.

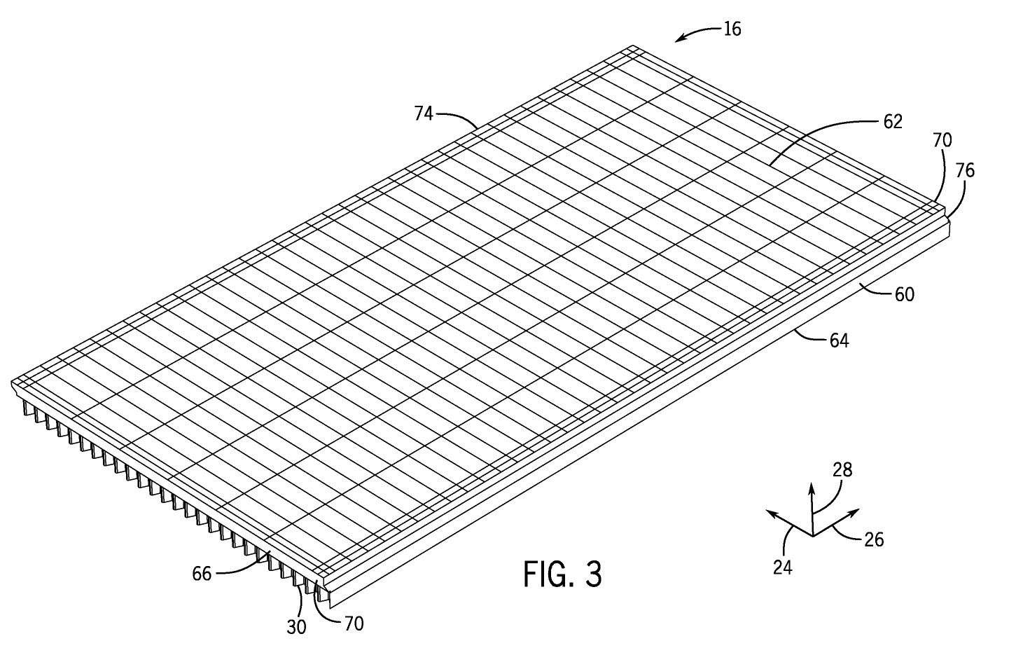

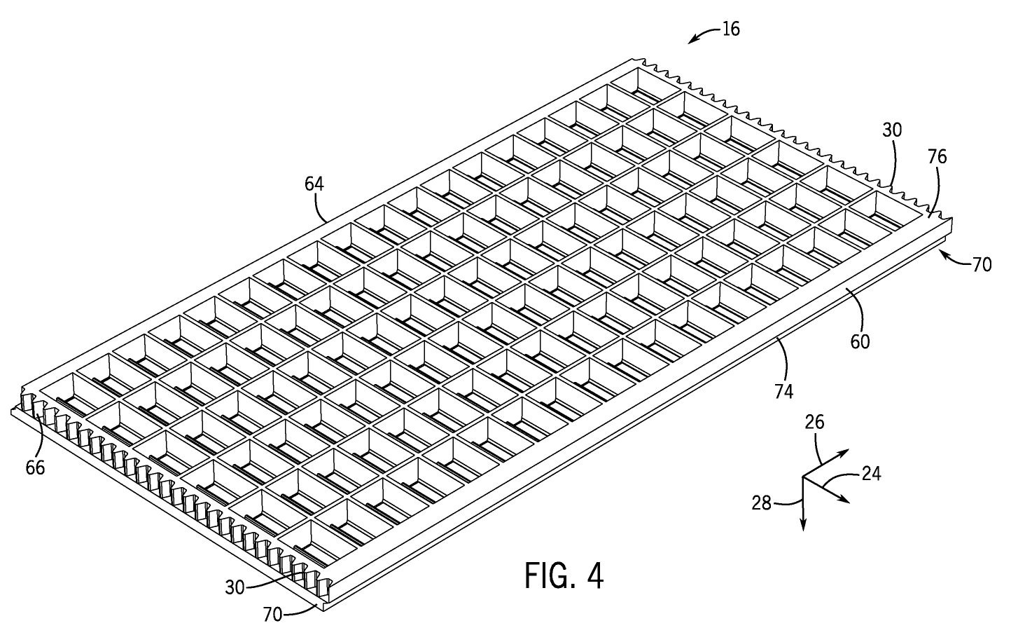

FIG. 3 is a top perspective view of the screen 16 of FIG. 2, and FIG. 4 is a bottom perspective view of the screen 16 of FIG. 2. As shown, the screen 16 includes the screen frame 60 and the screen filter 62. The screen frame 60 may include or provide the leading edge 74 and the trailing edge 64 spaced apart from one another along the longitudinal axis 24 of the screen 16. As noted herein, in embodiments without latch features along the leading edge 74 and the trailing edge 64, the leading edge 74 and the trailing edge 64 may have the same structure such that the screen 16 may be installed with either longitudinal side facing the feed end 20 (e.g., either longitudinal side may form or be used as the leading edge 74).

Further, in FIGS. 3 and 4, the screen frame 60 includes the first side member 66 that extends along the longitudinal axis 24 of the screen 16 (e.g., between the leading edge 74 and the trailing edge 64 on a first lateral side of the screen 16) and a second side member 76 that that extends along the longitudinal axis 24 of the screen 16 (e.g., between the leading edge 74 and the trailing edge 64 on a second lateral side of the screen 16 opposite the first lateral side of the screen 16). It should be appreciated that the first side member 66, the second side member 76, or both may include or be coupled to a respective gear rack 30 of the at least one gear rack 30. In FIGS. 3 and 4, each gear rack 30 of the at least one gear rack 30 is laterally recessed and/or covered by a respective ledge portion 70 of the screen 16 (e.g., relative to the vertical axis 28; when installed in the shaker housing 12 of FIG. 1).

Advantageously, in embodiments without latch features along the leading edge 74 and the trailing edge 64, it may be desirable to provide the first side member 66 and the second side member 76 with a same or corresponding structure (e.g., identical structure, geometry, configuration; mirrored so respective gear racks 30 face toward or are open to opposite lateral sides; only minor variations due to manufacturing tolerances). Thus, the screen 16 may be installed with either lateral side facing the at least one gear 32 of FIGS. 1 and 2 (e.g., either lateral side may engage the at least one gear 32). It should also be appreciated that the screen 16 may include only one gear rack 30, such as only along the first side member 66 (e.g., with the second side member 76 being devoid of any gear rack 30; having a flat laterally facing surface) or only along the second side member 76 (e.g., with the first side member 66 being devoid of any gear rack 30; having a flat laterally facing surface).

In certain embodiments, regardless of whether latch features are present, it should be appreciated that it may be desirable to utilize multiple gears 32 to engage the opposite lateral sides of the screen 16 (e.g., the respective gear rack 30 along the first side member 66 and the respective gear rack 30 along the second side member 76). For example, at least one gear 32 may be positioned in the shaker housing 12 of FIG. 1 to engage the respective gear rack 30 along the first side member 66, and at least one additional gear 32 may be positioned in the shaker housing 12 of FIG. 1 to engage the respective gear rack 30 along the second side member 76. In such cases, the multiple gears 32 on the opposite lateral sides of the screen 16 may rotate (e.g., one in the first gear rotational direction and one in the second rotational direction) to move the screen 16 toward the feed end 20 of the shaker housing 12 of FIG. 1, and the multiple gears 32 on the opposite lateral sides of the screen 16 may rotate (e.g., one in the second gear rotational direction and one in the first gear rotational direction) to move the screen 16 toward the discharge end 22 of the shaker housing 12 of FIG. 1. In some such cases, only one of the multiple gears 32 on the opposite lateral sides of the screen 16 may be actively driven (e.g., fixed to the drive shaft 42), while the other one of the multiple gears 32 may merely rotate passively to provide structural support to guide the screen 16 within the shaker housing 12 of FIG. 1. In some such cases, each of the multiple gears 32 on the opposite lateral sides of the screen 16 may be actively driven (e.g., fixed to a respective drive shaft 42, which may be rotated in simultaneously and in a coordinated manner, such as a same rate, in opposite rotational directions) to move the screen 16 within the shaker housing 12 of FIG. 1.

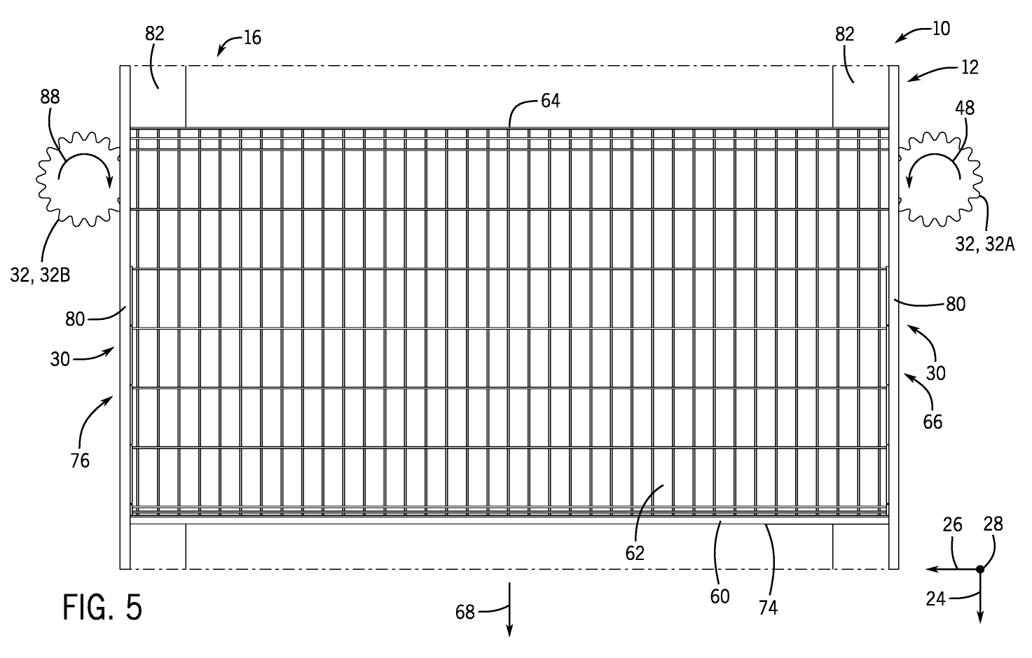

FIG. 5 is a top view of the screen 16 of FIG. 2 within a portion of the shaker system 10 of FIG. 1, in accordance with an embodiment of the present disclosure. As shown, the screen 16 includes the screen frame 60 and the screen filter 62. The screen frame 60 may include or provide the leading edge 74 and the trailing edge 64 spaced apart from one another along the longitudinal axis 24 of the screen 16. As noted herein, in embodiments without latch features along the leading edge 74 and the trailing edge 64, the leading edge 74 and the trailing edge 64 may have the same structure such that the screen 16 may be installed with either longitudinal side facing the feed end 20 (e.g., either longitudinal side may form or be used as the leading edge 74).

Further, in FIG. 5, the screen frame 60 includes the multiple frame members, such as the first side member 66 and a second side member 76. In FIG. 5, the first side member 66 and the second side member 76 include or are coupled to a respective gear rack 30. Further, in FIG. 5, each gear rack 30 is laterally recessed and/or covered, such as by a respective ledge portion 70 of the screen 16 (e.g., FIGS. 2-4). In certain embodiments, each gear rack 30 may additionally or alternatively be covered by a frame portion 80 (e.g., guide member; bridge) when the screen 16 is position in the shaker housing 12. For example, the screen 16 may be loaded or supported on tracks 82 of the shaker housing 12, such that the screen 16 is positioned between the tracks 82 and the frame portion 80 along the vertical axis 28. The frame portion 80 may therefore provide support to the screen 16 (e.g., retain the screen 16 on the tracks 82) and/or the frame portion 80 may block debris (e.g., the cuttings) from reaching the at least one gear rack 30 and/or interfering (e.g., blocking) in engagement between the at least one gear rack 30 and the at least one gear 32.

As noted herein, it may be desirable to provide and/or utilize multiple gears 32 (e.g., a first gear 32A and a second gear 32B) on opposite lateral sides of the shaker housing 12. Accordingly, the multiple gears 32 may then engage the opposite lateral sides of the screen 16 (e.g., the respective gear rack 30 along the first side member 66 and the respective gear rack 30 along the second side member 76). For example, the first gear 32A may be positioned in or along the shaker housing 12 to engage the respective gear rack 30 along the first side member 66, and the second gear 32B may be positioned in the shaker housing 12 to engage the respective gear rack 30 along the second side member 76. In such cases, the multiple gears 32 on the opposite lateral sides of the screen 16 may rotate (e.g., the first gear 32A in the first gear rotational direction, as shown by the arrow 48, and the second gear 32B in a second gear rotational direction, as shown by arrow 88; the second gear rotational direction is opposite the first gear rotational direction) to move the screen 16 in the first screen direction, as shown by the arrow 68 (e.g., toward the feed end 20 of the shaker housing 12 of FIG. 1). Further, the multiple gears 32 on the opposite lateral sides of the screen 16 may rotate (e.g., the first gear 32A in the second gear rotational direction and the second gear 32B in the first gear rotational direction) to move the screen 16 in the second screen direction that is opposite the first screen direction (e.g., toward the discharge end 22 of the shaker housing 12 of FIG. 1).

In some such cases, only one of the multiple gears 32 on the opposite lateral sides of the screen 16 may be actively driven (e.g., fixed to a respective drive shaft, such as the drive shaft 42 of FIG. 1), while the other one of the multiple gears 32 may merely rotate passively to provide structural support to guide the screen 16 within the shaker housing 12. In some such cases, each of the multiple gears 32 on the opposite lateral sides of the screen 16 may be actively driven (e.g., fixed to a respective drive shaft, which may be rotated together in opposite rotational directions) to move the screen 16 within the shaker housing 12 as described herein.

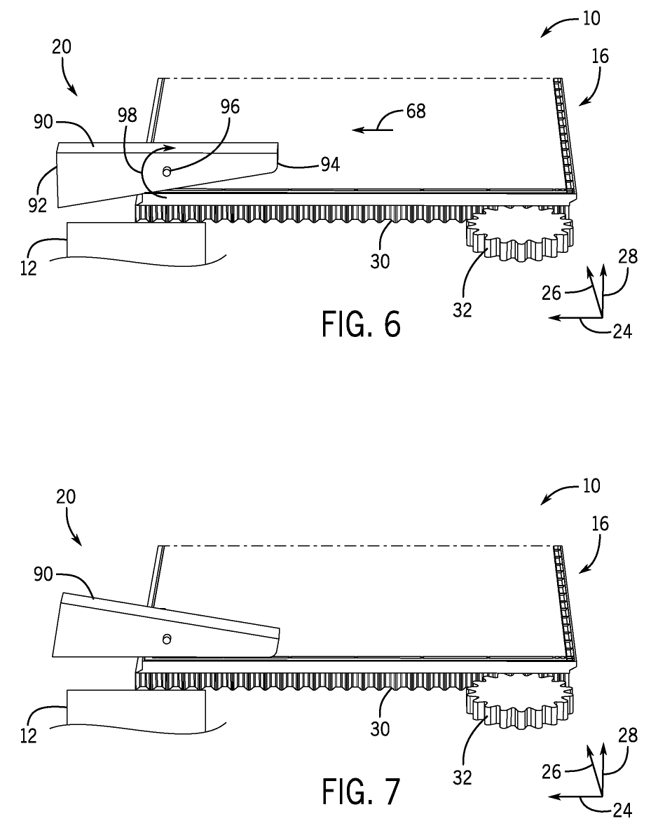

FIG. 6 is a side perspective view of the screen 16 of FIG. 2 in contact with a clamp 90 (e.g., wedge; rotatable clamp) within a portion of the shaker system 10 of FIG. 1, in accordance with an embodiment of the present disclosure. Additionally, FIG. 7 is a side perspective view of the screen 16 of FIG. 2 engaged by the clamp 90 of FIG. 6 within the portion of the shaker system 10 of FIG. 1, in accordance with an embodiment of the present disclosure. In FIG. 6, the clamp 90 is in a disengaged position (e.g., disengaged configuration; raised configuration; open configuration) in which the clamp 90 does not hold the screen 16 within the shaker housing 12 of the shaker system 10. In FIG. 7, the clamp 90 is in an engaged position (e.g., engaged configuration; lowered configuration; closed configuration) in which the clamp 90 holds the screen 16 within the shaker housing 12 of the shaker system 10. For example, in the engaged position the clamp 90 blocks movement of the screen 16 toward the discharge end 22 of FIG. 1 and/or supports the screen 16 within the shaker housing 12 of the shaker system 10.

As described herein, rotation of the at least one gear 32 that engages the at least one gear rack 30 drives the screen 16 in the first screen direction, as shown by the arrow 68, toward the clamp 90 at or proximate to the feed end 20. As the screen 16 moves in the first screen direction toward the clamp 90, the clamp 90 may be in the disengaged position with a first end 92 of the clamp 90 in a lower first end position along the vertical axis 28 and with a second end 94 of the clamp 90 in a higher second end position along the vertical axis 28.

As the screen 16 moves in the first screen direction toward the clamp 90, the screen 16 will eventually contact the clamp 90, as shown in FIG. 6. In particular, the screen 16 may contact the clamp 90 rearward (e.g., along the longitudinal axis 24 of the shaker housing 12) and/or below (e.g., along the vertical axis 28 of the shaker housing 12) of a pivot 96 of the clamp 90. The pivot 96 may include a pin (e.g., rod; circular cross-sectional area) that is fixed to the shaker housing 12 and that extends laterally from the shaker housing 12, and the clamp 90 may be rotatably mounted to the pin (e.g., the pin may extend through a lateral opening in the clamp 90 to enable the clamp 90 to rotate about the pin). However, it should be appreciated that the pivot 96 may have any suitable structure that enables rotation and operation of the clamp 90 as described herein.

In any case, such contact between the screen 16 and the clamp 90 may cause rotation of the clamp 90 about the pivot 96, as shown by arrow 98. Thus, this may cause the first end 92 of the clamp 90 to move from the lower first end position to a higher first end position along the vertical axis 28, as well as cause the second end 94 of the clamp 90 to move from the higher second end position to a lower second end position along the vertical axis 28. Accordingly, such contact may also be considered to cause the clamp 90 to transition from the disengaged position of FIG. 6 to the engaged position of FIG. 7. In this way, the screen 16 may be clamped into (e.g., held, secured) within the shaker housing 12 by the clamp 90 automatically by movement of the screen 16 via the at least one gear 32 and the at least one gear rack 30.

While one clamp 90 is shown in FIGS. 6 and 7 to facilitate discussion, it should be appreciated that two clamps 90 may be provided on opposite lateral sides of the shaker housing 12 (e.g., one clamp 90 to engage each opposite lateral side of the screen 16). Advantageously, the clamp(s) 90 may work together with the at least one lock 50 that may lock the at least one gear 32 (e.g., block rotation of the at least one gear 32). Thus, to remove the screen 16 from the shaker housing 12, the clamp(s) 90 are adjusted to the disengaged configuration and the at least one lock 50 is unlocked (e.g., actuated). Indeed, together, the clamp(s) 90 and the at least one lock 50 may provide sufficient support to retain the screen 16 within the shaker housing 12 during operation of the shaker system 10 to separate the solids. For example, in some cases without the at least one lock 50 (and the at least one gear 32 and the at least one gear rack) described herein, the clamp(s) 90 (e.g., only the clamp(s) 90) having the structure and operation shown in FIGS. 6 and 7) may provide an insufficient and/or relatively low level of support to retain the screen 16 within the shaker housing 12 during operation of the shaker system 10 to separate the solids.

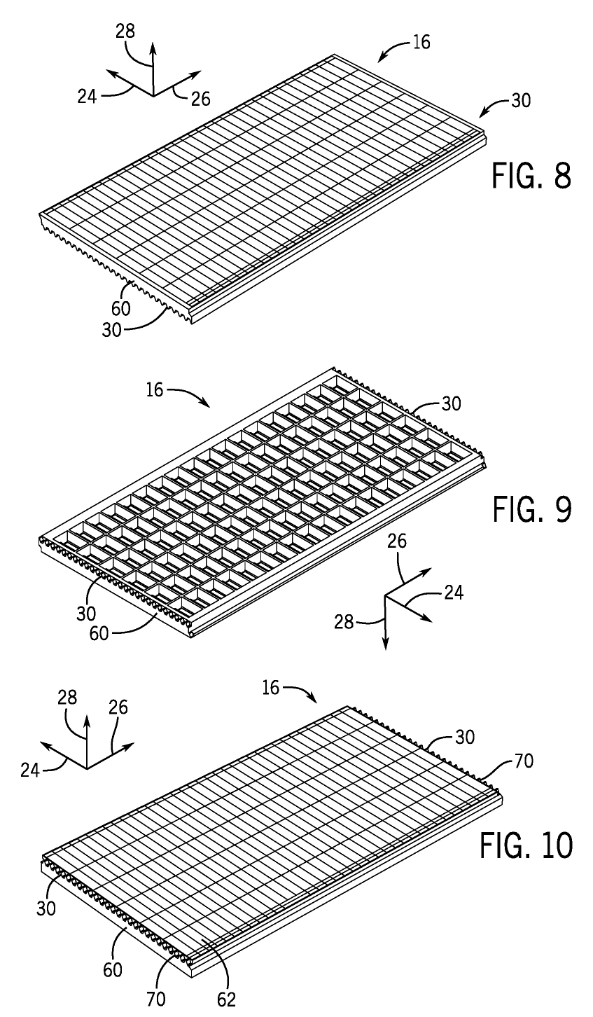

It should be appreciated that the screen 16 may include the at least one gear rack 30 in various positions and/or configurations, and the gear assembly 34 and/or the shaker housing 12 may be modified accordingly to accommodate and/or move the screen 16 as described herein. Accordingly, FIGS. 8-11 provide examples of the screen 16 with the at least one gear rack 30 in various positions and/or configurations.

FIG. 8 is a top perspective view of the screen 16 that may be utilized in the shaker system 10 of FIG. 1, in accordance with an embodiment of the present disclosure. FIG. 9 is a bottom perspective view of the screen 16 of FIG. 8, in accordance with an embodiment of the present disclosure. In FIGS. 8 and 9, the screen 16 includes the at least one gear rack 30 with a series of teeth (e.g., alternating protrusions and grooves) that face toward and are open to a lower side of the screen 16 (e.g., bottom side; face toward and are open along the vertical axis 28). Thus, in FIGS. 8 and 9, the at least one gear rack 30 is configured to engage with the at least one gear that is positioned (e.g., oriented) to rotate about the lateral axis 26 to drive the screen 16 along the longitudinal axis 24. As shown in FIGS. 8 and 9, as a result of the series of teeth that face toward and are open to the lower side of the screen 16, the at least one gear rack 30 is covered by the screen frame 60 of the screen 16. In this way, the screen frame 60 may block debris (e.g., the cuttings) from reaching the at least one gear rack 30 and/or interfering (e.g., blocking) in engagement between the at least one gear rack 30 and the at least one gear.

FIG. 10 is a top perspective view of the screen 16 that may be utilized in the shaker system 10 of FIG. 1, in accordance with an embodiment of the present disclosure. In FIG. 10, the screen 16 includes the at least one gear rack 30 with a series of teeth (e.g., alternating protrusions and grooves) that face toward and are open to an upper side of the screen 16 (e.g., top side; face toward and are open along the vertical axis 28). Thus, in FIG. 10, the at least one gear rack 30 is configured to engage with the at least one gear that is positioned (e.g., oriented) to rotate about the lateral axis 26 to drive the screen 16 along the longitudinal axis 24. As shown in FIG. 10, the at least one gear rack 30 is covered by the ledge portion 70 of the screen 16. The ledge portion 70 of the screen 16 may include a portion of the screen filter 62 that is supported on the screen frame 60. In this way, the ledge portion 70 may block debris (e.g., the cuttings) from reaching the at least one gear rack 30 and/or interfering (e.g., blocking) in engagement between the at least one gear rack 30 and the at least one gear.

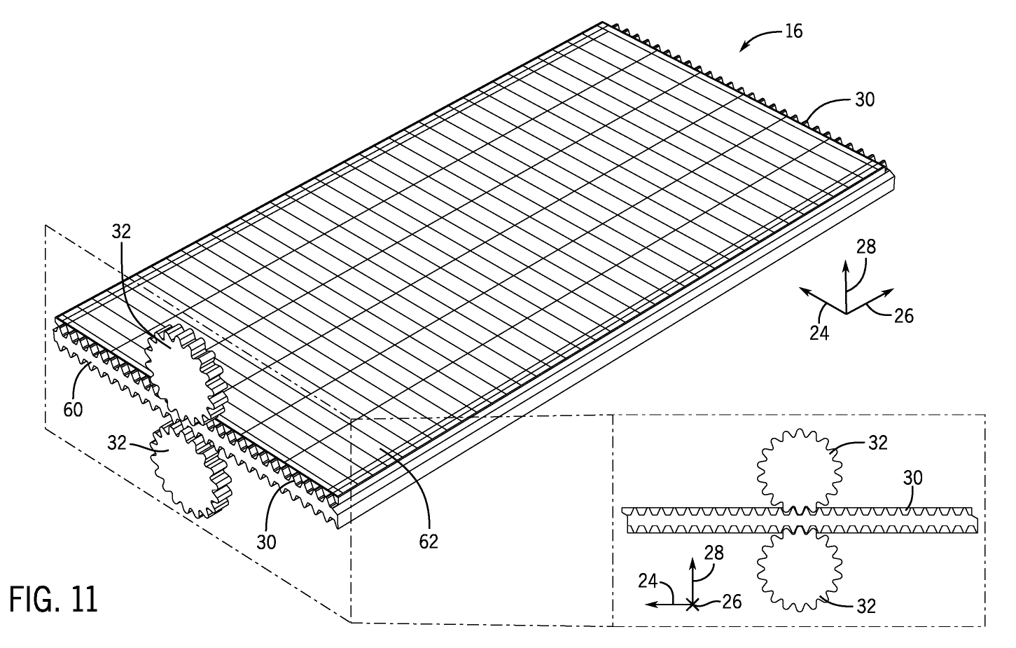

FIG. 11 is a top perspective view of the screen 16 that may be utilized in the shaker system 10 of FIG. 1, in accordance with an embodiment of the present disclosure. In FIG. 11, the screen 16 includes the at least one gear rack 30 shown in FIGS. 8-10 (e.g., combines the at least one gear rack 30 shown in FIGS. 8-10). Thus, the screen 16 includes the at least one gear rack 30 with a series of teeth (e.g., alternating protrusions and grooves) that face toward and are open to both a lower side and an upper side of the screen 16 (e.g., bottom and top side; face toward and are open along the vertical axis 28). Thus, in FIG. 11, the at least one gear rack 30 is configured to engage with the at least one gear 32 that is positioned (e.g., oriented) to rotate about the lateral axis 26 to drive the screen 16 along the longitudinal axis 24. As shown in FIG. 11, the at least one gear rack 30 is covered by the portion of the screen filter 62 that is supported on the screen frame 60. In this way, the screen frame 60 may block debris (e.g., the cuttings) from reaching the at least one gear rack 30 and/or interfering (e.g., blocking) in engagement between the at least one gear rack 30 and the at least one gear.

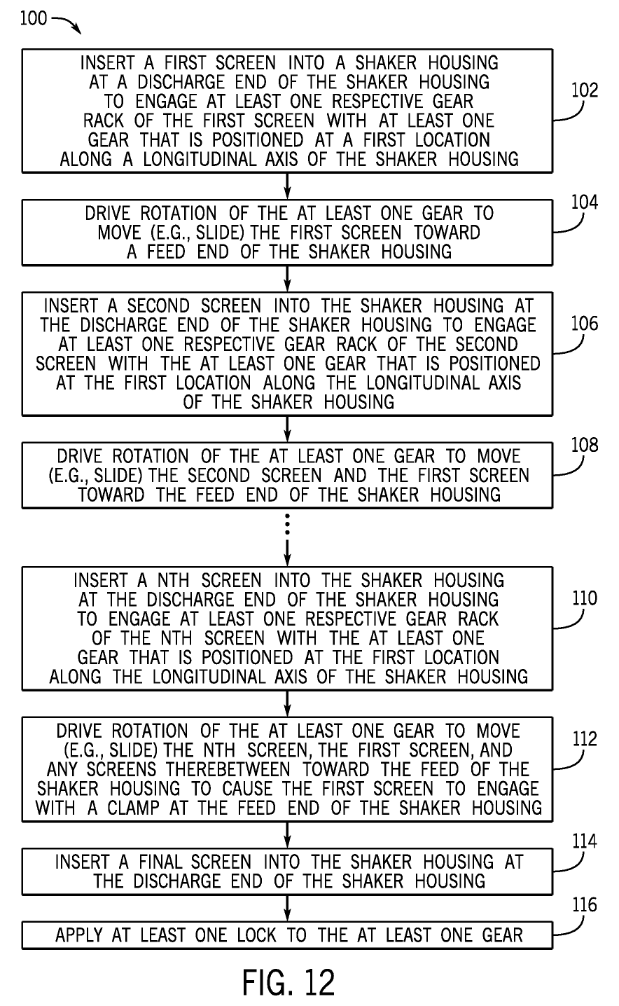

FIG. 12 is a flow diagram of a method 100 of installing multiple screens (e.g., the multiple screens 16 of FIG. 1) into a shaker housing (e.g., the shaker housing 12 of FIG. 1) a shaker system (e.g., the shaker system 10 of FIG. 1), in accordance with an embodiment of the present disclosure. The method 100 disclosed herein includes various steps represented by blocks. It should be noted that at least some of the blocks of the method 100 may be performed as an automated procedure (e.g., via instructions from an electronic controller) and/or at least some blocks of the method 100 may be performed as a manual procedure (e.g., via manual inputs and/or handling by a human operator). Although the flow diagram illustrates the blocks in a certain sequence, it should be understood that the blocks may be performed in any suitable order and certain blocks may be carried out simultaneously, where appropriate. Further, certain blocks may be omitted and/or other blocks may be added.

In block 102, the method 100 may include inserting a first screen into a shaker housing at a discharge end of the shaker housing. The first screen may be placed so as to engage at least one respective gear rack (e.g., a series of teeth) of the first screen with at least one gear (e.g., spur gear; toothed wheel) that is positioned at a first location along a longitudinal axis of the shaker housing. As noted herein, the at least one respective gear rack may include one or two respective gear racks on one or both lateral sides of the first screen, and each of the at least one respective gear rack may be open to a respective lateral side or a vertical side of the first screen, for example. Further, the at least one gear may be positioned (e.g., oriented) to engage the at least one respective gear rack.

In block 104, the method 100 may include driving rotation of the at least one gear to move (e.g., slide, drive) the first screen toward a feed end of the shaker housing. As noted herein, the at least one gear may be driven via a handle and/or a drive shaft. For example, in certain embodiments, the handle may be accessible from an exterior of the shaker housing, such as at the discharge end of the shaker housing. Further, rotation of the handle may drive rotation of the drive shaft, which may be coupled to the at least one gear to cause the rotation of the at least one gear. For example, the drive shaft may extend from and/or be fixed to the handle and may also include or be coupled to a worm gear that engages the at least one gear to cause the rotation of the at least one gear (e.g., the drive shaft is transverse, such as perpendicular, to a respective axis of rotation of the at least one gear; rotation of the drive shaft about the longitudinal axis of the shaker housing drives rotation of the at least one gear about a vertical axis of the shaker housing). As another example, the drive shaft may extend from and/or be coupled to the handle (e.g., fixed; via an intermediate gear), and the drive shaft may also be fixed to the at least one gear to cause the rotation of the at least one gear (e.g., the drive shaft is coaxial with the at least one gear; extending along the vertical axis of the shaker housing or along a lateral axis of the shaker housing).

In block 106, the method 100 may include inserting a second screen into the shaker housing at the discharge end of the shaker housing. The second screen may be placed so as to engage at least one respective gear rack (e.g., a series of teeth) of the second screen with the at least one gear that is positioned at the first location along the longitudinal axis of the shaker housing. The block 106 may be carried out once the first screen clears (e.g., no longer engages and/or is no longer driven by) the at least one gear that is positioned at the first location along the longitudinal axis of the shaker housing and/or once there is sufficient space to insert the second screen into the shaker housing adjacent to the first screen. As noted herein, the second screen may have a same structure as the first screen (e.g., to facilitate manufacturing and/or operations).

In block 108, the method 100 may include driving rotation of the at least one gear to move (e.g., slide, drive) the second screen and the first screen toward the feed end of the shaker housing. As noted herein, the at least one gear may be driven via the handle and/or the drive shaft. Further, a leading edge of the second screen may contact a trailing edge of the first screen, such that movement of the second screen via the rotation of the at least one gear also causes movement of the first screen via the contact between the leading edge of the second screen and the trailing edge of the first screen. Additionally, as noted herein, the leading edge and the trailing edge may include latching features (e.g., to engage and block separation of the first screen and the second screen) or may be devoid of latching features (e.g., flat longitudinally facing surfaces, optionally with a seal element).

In block 110, the method 100 may include inserting an n th screen into the shaker housing at the discharge end of the shaker housing. The n th screen may be placed so as to engage at least one respective gear rack (e.g., a series of teeth) of the n th screen with the at least one gear that is positioned at the first location along the longitudinal axis of the shaker housing. The block 110 may be carried out once a previous screen clears (e.g., no longer engages and/or is no longer driven by) the at least one gear that is positioned at the first location along the longitudinal axis of the shaker housing and/or once there is sufficient space to insert the n th screen into the shaker housing adjacent to the previous screen. As noted herein, the n th screen may have a same structure as the first screen (e.g., to facilitate manufacturing and/or operations).

In block 112, the method 100 may include driving rotation of the at least one gear to move (e.g., slide, drive) the n th screen, the first screen, and any screens therebetween (e.g., the second screen and/or additional screens to fill a basket of the shaker housing) toward the feed end of the shaker housing. As noted herein, the at least one gear may be driven via the handle and/or the drive shaft. Further, a leading edge of the n th screen may contact a trailing edge of the previous screen, such that movement of the n th screen via the rotation of the at least one gear also causes movement of the previous screen via the contact between the leading edge of the n th screen and the trailing edge of the previous screen. Any additional screens (e.g., the first screen and any screens between the n th screen and the first screen) may be driven via respective contact between respective leading edges and respective trailing edges. Additionally, as noted herein, the leading edges and the trailing edges may include latching features or may be devoid of latching features. With installation of the n th screen in this manner, the first screen may reach and/or engage a clamp at or proximate to the feed end of the shaker housing. For example, the first screen may contact the clamp to engage the clamp, which may hold the first screen within the shaker housing.

In block 114, the method 100 may include inserting a final screen into the shaker housing at the discharge end of the shaker housing (e.g., to fill the basket of the shaker housing). In certain embodiments, at least one respective gear rack of the final screen may engage with the at least one gear that is positioned at the first location along the longitudinal axis of the shaker housing. In block 116, at least one lock may be applied (e.g., locked, actuated) to the at least one gear that is positioned at the first location along the longitudinal axis of the shaker housing. As described herein, when the at least one lock is applied, the at least one lock may contact and/or engage the handle, the drive shaft, and/or the at least one gear directly to block rotation of the at least one gear. In this way, the clamp and the at least one lock may hold the multiple screens within the shaker housing (e.g., block movement of the multiple screens toward the discharge end of the shaker housing).

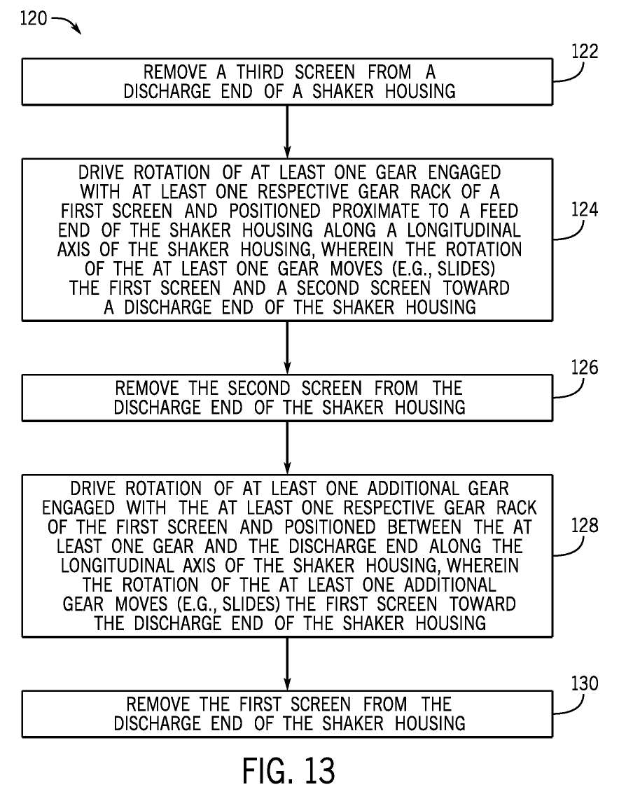

FIG. 13 is a flow diagram of a method 120 of removing multiple screens (e.g., the multiple screens 16 of FIG. 1) from a shaker housing (e.g., the shaker housing 12 of FIG. 1) a shaker system (e.g., the shaker system 10 of FIG. 1), in accordance with an embodiment of the present disclosure. The method 120 disclosed herein includes various steps represented by blocks. It should be noted that at least some of the blocks of the method 120 may be performed as an automated procedure (e.g., via instructions from an electronic controller) and/or at least some blocks of the method 120 may be performed as a manual procedure (e.g., via manual inputs and/or handling by a human operator). Although the flow diagram illustrates the blocks in a certain sequence, it should be understood that the blocks may be performed in any suitable order and certain blocks may be carried out simultaneously, where appropriate. Further, certain blocks may be omitted and/or other blocks may be added.

To facilitate discussion, the method 120 is described with reference to a first screen, a second screen, and a third screen. For purposes of discussion, when installed together in the shaker housing, it should be considered that the first screen, the second screen, and the third screen form a deck and fill a basket of the shaker housing. Further, for purposes of discussion, when installed together in the shaker housing, it should be considered that the first screen is positioned closest to the feed end, the third screen is positioned closest to the discharge end, and the second screen is positioned between the first screen and the third screen along a longitudinal axis of the shaker housing. It should be appreciated that the method 120 may be adapted for use with any of a number of screens (e.g., 1, 2, 3, 4, 5, 6, or more, such as by incorporating a suitable number of gears distributed along the longitudinal axis of the shaker housing).

In block 122, the method 120 may include removing the third screen from the discharge end of the shaker housing. For example, the third screen may be the final screen that is accessible from the discharge end (e.g., the operator may apply a force to remove the third screen from the shaker housing). However, the first screen and the second screen may not be accessible (or at least not readily accessible) from the discharge end.

In block 124, the method 120 may include driving rotation of at least one gear (e.g., spur gear; toothed wheel) engaged with at least one respective gear rack (e.g., a series of teeth) of the first screen. The at least one gear may be positioned proximate to the feed end of the shaker housing along the longitudinal axis of the shaker housing. Further, the rotation of the at least one gear moves (e.g., slides, drives) the first screen and the second screen toward the discharge end of the shaker housing.

With respect to the block 124 and as noted herein, the at least one respective gear rack may include one or two respective gear racks on one or both lateral sides of the first screen, and each of the at least one respective gear rack may be open to a respective lateral side or a vertical side of the first screen, for example. Further, the at least one gear may be positioned (e.g., along the longitudinal axis of the shaker housing; oriented) to engage the at least one respective gear rack (e.g., while the first screen is at the feed end of the shaker housing; while the first screen is engaged by the clamp).

Additionally, with respect to the block 124, the at least one gear may be driven via a handle and/or a drive shaft. For example, in certain embodiments, the handle may be accessible from an exterior of the shaker housing, such as at the discharge end of the shaker housing and/or a lateral side of the shaker housing. Further, rotation of the handle may drive rotation of the drive shaft, which may be coupled to the at least one gear to cause the rotation of the at least one gear.

Additionally, with respect to the block 124, a leading edge of the second screen may contact a trailing edge of the first screen, such that movement of the first screen via the rotation of the at least one gear also causes movement of the second screen via the contact between the leading edge of the second screen and the trailing edge of the first screen.

In block 126, the method 120 may include removing the second screen from the discharge end of the shaker housing. For example, upon completion of the block 124, the second screen may be at and/or accessible from the discharge end (e.g., the operator may apply a force to remove the second screen from the shaker housing). However, the first screen may still not be accessible (or at least not readily accessible) from the discharge end.

In block 128, the method 120 may include driving rotation of at least one additional gear (e.g., spur gear; toothed wheel) engaged with the at least one respective gear rack of the first screen. The at least one additional gear may be positioned between the at least one gear (e.g., the at least one gear of the block 124) and the discharge end of the shaker housing along the longitudinal axis of the shaker housing. Further, the rotation of the at least additional one gear moves (e.g., slides, drives) the first screen further toward the discharge end of the shaker housing.

With respect to the block 128, it should be appreciated that the at least one gear and the at least one additional gear may be positioned (e.g., spaced apart along the longitudinal axis of the shaker housing) to enable the at least one gear proximate to the feed end to move the first screen to hand off the first screen to the at least one additional gear that is closer to the discharge end.

With respect to the block 128 and as noted herein, the at least one additional gear may be positioned (e.g., along the longitudinal axis of the shaker housing; oriented) to engage the at least one respective gear rack (e.g., after the first screen moves away from the feed end of the shaker housing via the rotation of the at least one gear in the block 124).

Additionally, with respect to the block 128, the at least one additional gear may be driven via a handle and/or a drive shaft. For example, in certain embodiments, the handle may be accessible from an exterior of the shaker housing, such as at the discharge end of the shaker housing and/or the lateral side of the shaker housing. Further, rotation of the handle may drive rotation of the drive shaft, which may be coupled to the at least one additional gear to cause the rotation of the at least one additional gear. As noted herein, each of the at least one gear and the at least one additional gear may be independently rotated via a dedicated handle and a dedicated drive shaft; however, any variety of gear assemblies, linkages, connectors, and so forth suitable to carry out techniques described herein are envisioned. For example, a single handle may drive rotation of the at least one gear and the at least one additional gear together (e.g., the single handle coupled to a single drive shaft with respective worm gears to engage the at least one gear and the at least one additional gear).

In block 130, the method 120 may include removing the first screen from the discharge end of the shaker housing. For example, upon completion of the block 128, the first screen may be at and/or accessible from the discharge end (e.g., the operator may apply a force to remove the first screen from the shaker housing).

It should be appreciated that the method 120 may enable use of the multiple screens that are devoid of latching features (e.g., the leading edges and the trailing edges are flat longitudinally facing surfaces, optionally with a seal element). However, as noted herein, the leading edges and the trailing edges may include latching features (e.g., to engage and block separation of the first screen and the second screen). When such latching features are present, then at least one gear at a single location along the longitudinal axis is sufficient to facilitate removal of the multiple screens from the shaker housing. For example, at least one gear proximate to the discharge end may be sufficient to install the multiple screens into the shaker housing (e.g., according to the method 100 of FIG. 12; via rotation of the at least one gear in respective rotational direction(s)), and also to remove the multiple screens from the shaker housing (e.g., via rotation of the at least one gear proximate to the discharge end in respective opposite rotational direction(s)). For example, the latching features may pull all connected screens (e.g., latched screens) of the multiple screens toward the discharge end upon engagement between the at least one gear and any one of the multiple screens.

It should be appreciated that the latching features may include any suitable form or configuration. For example, a first latch assembly may include a first latch feature (e.g., a groove) formed in a respective leading edge of one of the multiple screens, and a second latch feature (e.g., a protrusion) formed in a respective trailing edge of another one of the multiple screens. The first latch feature and the second latch feature may contact and engage with one another as the respective leading edge contacts with the respective trailing edge. Further, the first latch feature and the second latch feature may remain engaged (e.g., may not separate) upon application of a force along the longitudinal axis.

As noted herein, techniques disclosed herein may include automated steps (e.g., an electronic controller sends instructions control features of the shaker system, such as to drive rotation of the at least one gear). It should be appreciated that one or more seal elements (e.g., elastomer seal elements) may be provided between the multiple screens, such as to block fluid flow across an interface between adjacent screens. The one or more seal elements may have any suitable form and/or position. For example, the one or more seal elements may be along the leading edge, the trailing edge, or both. The one or more seal elements providing sealing (e.g., block fluid flow) between the multiple screens, but do not provide latching or connection (e.g., do not block separation) of the multiple screens.

Further, as noted herein, the gear assembly may have any of a variety of components and configurations to carry out the techniques disclosed herein. In addition to certain examples provided herein, it is envisioned that one handle, one driveshaft, and one gear on a first lateral side of the shaker housing (e.g., as shown in FIG. 1) may be rotated to install the multiple screens in the shaker housing (e.g., according to the method 100 of FIG. 12). Additionally, there may be various options to remove the multiple screens from the shaker housing, such as use of the latching features and the one gear (e.g., the same gear that is rotated to install the multiple screens in the shaker housing).

Another option may be to provide dedicated handles and dedicated drives shafts for multiple gears distributed along the longitudinal axis of the shaker housing. For example, each gear may be at a respective location along the longitudinal axis of the shaker housing, and each gear may be coupled to a dedicated drive shaft and a dedicated handle accessible along a lateral side of the shaker housing so that each gear may be rotated independently. In order to utilize this configuration, the one gear and the multiple gears may be capable of passively rotating and/or may be selectively disengaged (e.g., separated) from the multiple screens (e.g., when not being used to drive the multiple screens).

Yet another option may be to provide one additional handle, one additional drive shaft with multiple worm gears, and multiple gears on a second lateral side of the shaker housing. The multiple gears may be distributed along the longitudinal axis of the shaker housing. In such cases, the one additional handle may be rotated to remove the multiple screens from the shaker housing (e.g., according to the method 120 of FIG. 13). In order to utilize this configuration, the one gear and the multiple gears may be capable of passively rotating and/or may be selectively disengaged (e.g., separated) from the multiple screens (e.g., when not being used to drive the multiple screens). Further, in this configuration and in certain other configurations, the one gear may automatically operate as the at least one lock by being configured only to rotate in one direction (e.g., the first gear rotational direction), and in such cases selectively disengaging the one gear from the multiple screens may enable removal of the multiple screens (e.g., via rotation of the multiple gears). Such options are merely exemplary and are not intended to be exhaustive.

It should also be appreciated that the screen, the screen assembly, the gear assembly, and/or any related features may be utilized in other contexts (e.g., other than a shaker system and/or other than with drilling fluid). For example, the screen may be utilized in other types of filtering systems and/or in other industrial contexts.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents, and alternatives falling within the spirit and scope of the disclosure as defined by the following appended claims. For example, it should be appreciated that the any features shown in FIGS. 1-13 or described with reference to FIGS. 1-13 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A screen, comprising:
a screen comprising a screen frame and a screen filter, wherein the screen frame comprises:
lateral frame members on opposite lateral sides of the screen frame; and
at least one gear rack that extends along at least one frame member of the lateral frame members.

2. The screen of claim 1, wherein the at least one gear rack comprises a first gear rack that extends along a first lateral frame member of the lateral frame members and a second gear rack that extends along a second lateral frame member of the lateral frame members.

3. The screen of claim 2, wherein the first gear rack comprises respective teeth open toward a first lateral direction, and the second gear rack comprises respective teeth open toward a second lateral direction opposite the first lateral direction.

4. The screen of claim 1, wherein the at least one gear rack comprises teeth open toward a lateral axis of the screen or a vertical axis of the screen.

5. The screen of claim 1, comprising a ledge portion that extends laterally to cover the at least one gear rack relative to a vertical axis of the screen.

6. The screen of claim 1, wherein the screen comprises a leading edge and a trailing edge, and the at least one gear rack extends over at least 90 percent of a length of the screen between the leading edge to the trailing edge.

7. The screen of claim 1, wherein the screen comprises a leading edge and a trailing edge that are devoid of latching features.

8. A system, comprising:
a screen comprising a screen frame and a screen filter, wherein the screen frame comprises at least one gear rack; and
at least one gear configured to engage the at least one gear rack to facilitate installation of the screen within a housing.

9. The system of claim 8, wherein the at least one gear rack comprises a first gear rack that extends along a first lateral frame member of the screen frame and a second gear rack that extends along a second lateral frame member of the screen frame.

10. The system of claim 8, wherein the at least one gear rack comprises teeth open toward a lateral axis of the screen, and the at least one gear is configured to rotate about a vertical axis.

11. The system of claim 8, comprising:
a handle accessible at an exterior of the housing, wherein rotation of the handle is configured to drive rotation of the at least one gear, and the rotation of the at least one gear while the at least one gear is engaged with the at least one gear rack is configured to drive movement of the screen to facilitate the installation of the screen within the housing.

12. The system of claim 11, wherein the housing comprises a shaker housing that receives a fluid at a feed end, and the screen separates a liquid from solids in the fluid as the fluid travels toward a discharge end.

13. The system of claim 12, comprising a clamp proximate to the discharge end, wherein the clamp is configured to pivot to engage the screen upon contact with the screen.

14. The system of claim 10, comprising:
an additional screen comprising an additional screen frame and an additional screen filter, wherein the additional screen frame comprises at least one additional gear rack, and the at least one gear is configured to engage the at least one additional gear rack to facilitate installation of the additional screen and the screen within the housing.

15. A method, comprising:
inserting a first screen into a housing at a first end of the housing to engage at least one respective gear rack of the first screen with at least one gear that is positioned at a first location along a longitudinal axis of the housing; and
driving rotation of the at least one gear while the at least one gear is engaged with the at least one respective gear rack of the first screen to drive the first screen to move toward a second end of the housing to facilitate installation of the first screen in the housing.

16. The method of claim 15, comprising:
inserting a second screen into the housing at the first end of the housing to engage at least one respective gear rack of the second screen with the at least one gear that is positioned at the first location along the longitudinal axis of the housing; and
driving rotation of the at least one gear while the at least one gear is engaged with the at least one respective gear rack of the second screen to drive the second screen and the first screen to move toward the second end of the housing to facilitate installation of the second screen and the first screen in the housing.

17. The method of claim 16, wherein driving the rotation of the at least one gear while the at least one gear is engaged with the at least one respective gear rack of the second screen drives the second screen to move toward the second of the housing via direct contact between the at least one gear and the at least one respective gear rack of the second screen and drives the first screen to move toward the second end of the housing via contact between a leading edge of the second screen and a trailing edge of the first screen.

18. The method of claim 15, comprising:
inserting an additional screen into the housing at the first end of the housing to engage at least one respective gear rack of the additional screen with the at least one gear that is positioned at the first location along the longitudinal axis of the housing; and
driving rotation of the at least one gear while the at least one gear is engaged with the at least one respective gear rack of the additional screen to drive at least the additional screen and the first screen to move toward the second end of the housing until the first screen engages with a clamp proximate to the second end of the housing to facilitate installation of at least the additional screen and the first screen in the housing.

19. The method of claim 18, comprising actuating a lock to block rotation of the at least one gear to block movement of at least the additional screen and the first screen toward the first end of the housing.

20. The method of claim 18, comprising:
driving rotation of at least one additional gear while the at least one additional gear is engaged with the at least one respective gear rack of the first screen to drive at least the first screen to move toward the first end of the housing and to re-engage the at least one respective gear rack of the first screen with the at least one gear, wherein the at least one additional gear is positioned at a second location along the longitudinal axis of the housing; and
subsequently driving rotation of the at least one gear while the at least one gear is engaged with the at least one respective gear rack of the first screen to drive at least the first screen to move toward the first end of the housing to facilitate removal of at least the first screen from the housing.
